(19) United States
(12) Patent Application Publication
(10) Pub. No.: US 2008/0213458 A1
(43) Pub. Date: Sep. 4, 2008

(54) METHOD FOR USING INGREDIENTS TO ENRICH THE NUTRITIONAL CONTENT OF A FOOD PRODUCT WITHOUT ALTERING ITS SENSORY PROFILE

(75) Inventor: John Davin Anderson, Seattle, WA (US)

Correspondence Address: BLACK LOWE & GRAHAM, PLLC, 701 FIFTH AVENUE, SUITE 4800, SEATTLE, WA, 98104, US

(73) Assignee: Full Tank Foods, Inc., Seattle, WA (US)

(21) Appl. No.: 12/041,551

(22) Filed: Mar. 3, 2008

Related U.S. Application Data
(60) Provisional application No. 60/892,510, filed on Mar. 1, 2007.

(51) Int. Cl. A23L 1/30; A23L 1/29

(52) U.S. Cl. 426/648

(57) ABSTRACT

A food development method to enrich a target food product recipe by the addition of ingredients made into purees that when incorporated into a target food recipe replicate the taste, color, and texture of the target food product. The purees are designed to minimize impact on color, taste, and texture when added to a target food product recipe.

### PRIORITY CLAIM

This application claims priority from earlier filed U.S. Provisional Patent Application Serial No. 60/892,510 filed Mar. 1, 2007. The foregoing application is hereby incorporated by reference in its entirety as if fully set forth herein.

### FIELD OF THE INVENTION

This invention relates generally to a method for deriving a recipe for food products having known nutritional content based upon the presence of whole food nutrients.

### BACKGROUND OF INVENTION

Convenience food, or tertiary processed food, is commercially prepared food designed for ease of consumption. Products designated as convenience foods are often pre-prepared food stuffs that can be sold as hot, ready-to-eat dishes, as room temperature, shelf-stable products, or as refrigerated or frozen products that require minimal preparation, typically just heating, by the consumer.

Convenience foods often are sold in portion controlled, single serve packaging designed for portability for “on-the-go” or later eating. Critics have derided the increasing trend of convenience foods because of numerous issues. Diet-responsive conditions such as obesity, hypertension, hyperlipidemia, cancer, diabetes, and combinations thereof are readily caused or exacerbated by consumption of convenience foods.

To alleviate the concerns that many consumers have regarding consumption of convenience foods, producers of convenience foods have used methods of nutritional enhancement to increase the apparent food value of those convenience foods. Generally, the methods of nutritional enhancement involve fortification of meal components of the prepackaged meals by addition of chemical nutrients such as dietary minerals or vitamins. Referring to FIG. 1, regulations by the United States Department of Agriculture (USDA) require the display of nutritional information in a tabular form 9 for an exemplary macaroni and cheese product. In rows of the table, nutritional value of the product is shown. In a row 10, the content of Vitamin A is shown as a percentage of the USDA recommended daily allowance (RDA) of Vitamin A as would be present in a uniform single serving as set forth in a row 11. In a row 12, Vitamin C is likewise portrayed; in a row 15, dietary calcium; in a row 18, dietary iron. The degree of fortification is determined by a variety of factors, including the methods of processing, packaging, storing, and preparing the meals, the duration of storage, and the amounts of these elements desired for effective management of the diet-responsive condition.

The addition of chemical nutrients, however, has proven to be largely inadequate to meet all of the issues relating to health. For example, a growing area of interest is the effect upon human health of the presence of trace chemicals, collectively called phytochemicals. These antioxidant nutrients are typically found in edible plants, especially colorful fruits and vegetables, but also other organisms including seafood, algae, and fungi. One of the principal classes of phytochemicals is polyphenol antioxidants, chemicals which are known to provide certain health benefits to the cardiovascular system and immune system. Additionally, phytochemicals are known to down-regulate the formation of reactive oxygen species, key chemicals in cardiovascular disease. Also, whole foods such as colorful fruit and vegetable matter, as opposed to chemical nutrients, has been found desirable in order to preserve the presence of nutrients, known and unknown, in whole foods.

Additional of whole foods into convenience foods has proven extremely difficult because such convenience foods have attributes, such as flavor, texture, and color that account for their popularity. Whole foods tend, however, to have very distinctive characteristics that generally change those attributes of the food into which they are introduced. Simple mixture of whole foods into convenience foods simply changes the convenience food in a manner that makes the convenience food, as mixed, to be unpalatable.

There exists, then, an unmet need in the art to, in a systematic method, incorporate whole food additives into convenience foods to improve the nutritional makeup.

### SUMMARY OF THE INVENTION

A method of incorporation of natural ingredients into a target food product recipe is configured to modify a nutritional makeup of the target food product without significantly changing the target food's sensory attributes. Selective incorporation of at least one puree having known sensory and nutritional attributes in measured quantities modifies nutritional makeup without significant modification of the sensory attributes of the resulting food product.

In one, nonlimiting embodiment, at least one puree of vegetables is incorporated into the target food product in order to enhance the nutritional attributes of the target food product. The at least one puree is selected from, for example, yellow-based purees made from vegetables such as yellow potatoes, sweet potatoes, yellow winter squash, yellow corn, yellow beets, or rutabaga, amongst others. Other exemplary vegetable purees are made in a spectrum range of colors including green, orange, red, purple, blue and white. Combinations of colored purees can be combined to achieve alternative variations in color. For example, it may be desirable to combine a yellow-based puree and red-based purees to achieve a puree which is orange colored having a whole food vitamin C content. Examples of colored purees include, for orange-colors: purees made with pumpkin, carrots, yams, and orange beets, amongst others, or alternately, by combining yellow-based purees and red-based purees. Red-based purees have red beets, red pepper, red beans, and tomatoes, contributing colors from whole foods. To achieve purple, a puree including purple cauliflower, purple carrots, and purple potatoes, is a first example; while combining red-based purees and blue-based purees is a second example. Blue-based purees include blue potatoes, blue kale, and blue corn, amongst others. Green based purees include kale, chard, spinach, peas, green pepper, lima beans, soy beans, and black beans, amongst others, where special consideration is taken for the bitter taste of leafy green vegetables. White-based purees include cauliflower, white corn, white beans, black eyed peas, parsnips, parsnip, turnip, and taro, amongst others. While alternate embodiments exist for achieving a single colored puree, selection of a puree is also based upon nutritional attributes of the puree and the desired nutritional attributes in the target food.

These and other examples of the invention will be described in further detail below.

### BRIEF DESCRIPTION OF THE DRAWINGS

Preferred and alternative examples of the present invention are described in detail below with reference to the following drawings:

FIG. 1 is a prior art example of a required nutrition table;

FIG. 2 is a table configured to enable a embodiment of a method for producing formulations of target food products according to sensory attributes of a basic recipe and known attributes of purees;

FIG. 3 is a color wheel according to content of purees for incorporation into an interim product; and

FIG. 4 is flowchart for a qualitative embodiment for a method for producing formulations of target food products according to sensory attributes of a basic recipe and known attributes of purees.

### DETAILED DESCRIPTION OF THE PREFERRED EMBODIMENT

A method to develop a target food product having selected nutritional and sensory attributes, from a base recipe and incorporation of selected purees, each having known sensory and nutritional attributes. Not all food products are equally well suited for augmentation by the incorporation of purees; a target food product is selected to coincide with constraints consistent with incorporation of at least one puree.

Purees of whole food nutrients are generally most readily incorporated into foods having moisture content or between approximately 25 to 95 percent in a principal component. A principal component is a component that is distinctly identifiable in a product. Pasta-based foods, by way of non-limiting example, generally include a first and a second principal component, a noodle and a sauce respectively. While the noodle may not fall within the approximately 25 to 95 percent moisture content, the sauce component generally does. Pot pies, soups, stews, and pies would be other examples of food products having at least a first and second principle component of which at least one of the first or second principle components fall within the range of 25 to 95 percent moisture content.

Foods with a single principle component, such as frozen novelty items similar to Popsicle™ or the Mr. Freeze™ products, are suitable for augmentation by incorporation of purees. Single principle component foods having a single component with between 25 and 95 percent moisture content, such as uncooked brownies, will also suitably serve as target food products.

While the preferred embodiment of the present invention includes selecting target foods having a principal component of between 25 to 95 percent moisture content, the range for moisture content is not a necessary attribute of the target food product. The addition of puree to a product with a moisture content outside of this range will, however, significantly impact the shelf life (for items with low moisture content) and texture (particles will cloud a juice or water beverage over time) when used in composition of such target food products.

A target food is selected for production, having, in the preferred embodiment, a moisture content of between 25 and 95 percent. By way of nonlimiting example, for demonstration of a preferred embodiment, macaroni and cheese is set forth. Because the cheese sauce component does fall within between 25 and 95 percent moisture content, macaroni and cheese is a suitable target food product.

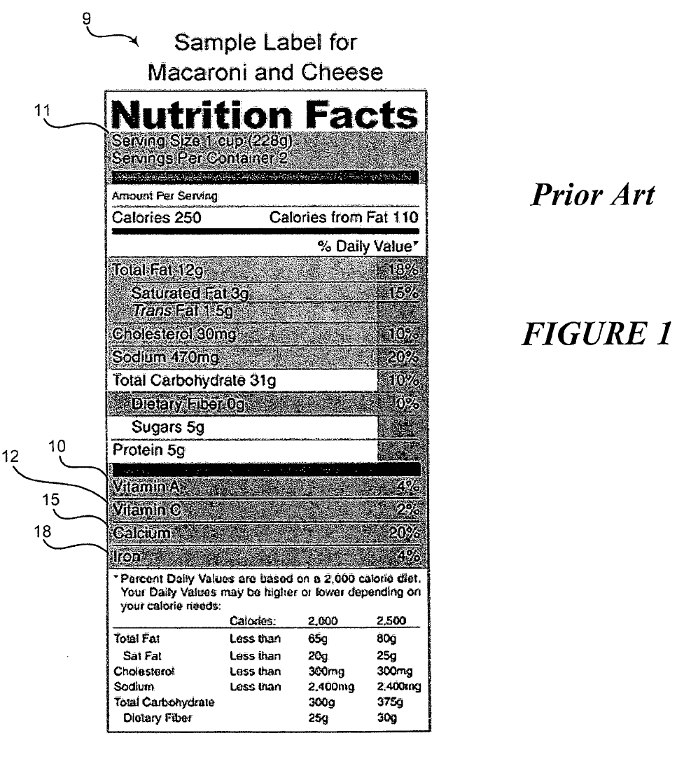

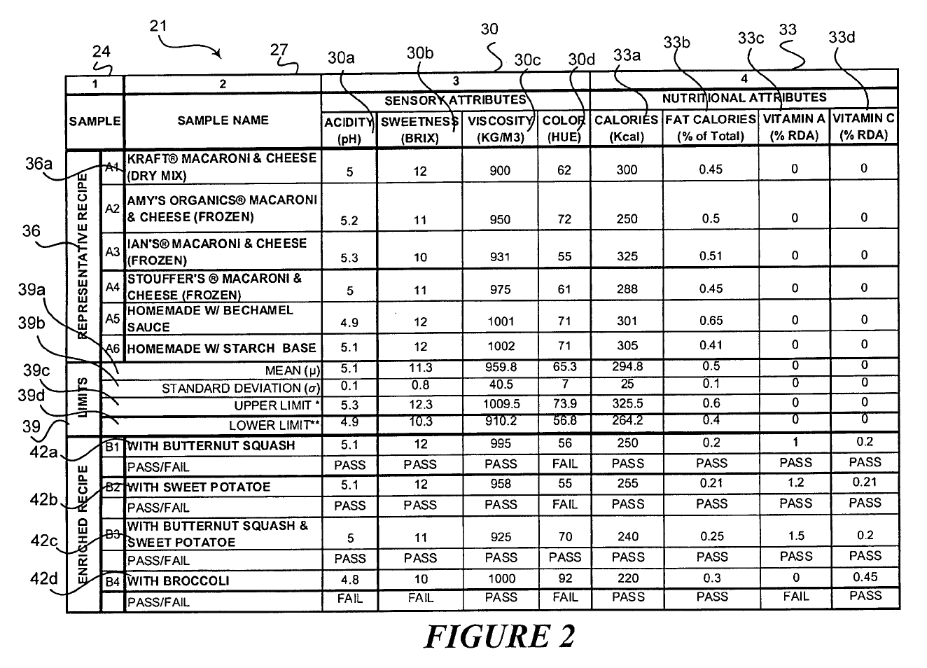

A table can be configured to derive content of the target food in development of a recipe. To that end, FIG. 2 sets forth the content of a table 21 having features to enable a nonlimiting embodiment of the invention. The method relies upon the fact that generally, the characteristics of a target food will be determined for a uniform serving having a uniform single serving size 11 (FIG. 1). Where, for example, the target food product has an designated amount of a nutrient present in the single serving size 11 (FIG. 1), a selected base recipe having that nutrient in a known amount can be altered by the addition of a puree having that nutrient in a distinct amount in the single serving size 11 (FIG. 1).

In a base recipe high in calories derived from dietary fat, the dietary fat per in the single serving size 11 (FIG. 1), diminishes with the addition of a puree, low in calories derived from dietary fat. As well, a base recipe low in a nutrient can be fortified with the addition of a puree with a greater density of the same nutrient. A regimented means of selection of which puree or purees and the quantity of each puree enables a method of deriving recipes for target food products. The method, then, includes selection of a target food product with selected nutritional and sensory attributes, selection of a base recipe having known nutritional and sensory attributes, and the incorporation of selected purees, in determined amounts each of known nutritional and sensory attributes.

Referring again to FIG. 2, the table 21 includes an identity column 24 tying each sample to a unique identifying code. Thus, as in the nonlimiting example of a first sample for analysis, that of Kraft™ Macaroni and Cheese in a row 36a, under the column 24, the unique code “A1” is assigned. In a verbose name column 27, in the row 36a, sample “A1” is identified as “Kraft™ Macaroni and Cheese (Dry Mix).”

While quantization of attributes of a sample is not necessary for practice of the invention, indeed every of the sensory attributes listed under a “Sensory Attributes” column 30 can be known and used in a purely qualitative manner known only by human observation, where a quality is knowable by a quantitative measurement. The table 21 is advantageously populated with numeric values representative of these qualities. Thus, under the main “Sensory Attributes” column 30, an “Acidity” subcolumn 30a, a “Sweetness” subcolumn 30b, a “Viscosity” subcolumn 30c, and a “Color” subcolumn 30d, populated with the quantitative measurements 5, 12, 900, and 62 respectively in the row 36, reflecting measured values for the Kraft™ product.

The table 21 is also advantageously populated with numeric values representative of the nutritional qualities of sampled food products as well. Thus, under the main “Nutritional Attributes” column 33, a “Calories” subcolumn 33a, a “Fat Calories” subcolumn 33b, a “Vitamin A” subcolumn 33c, and a “Vitamin C” subcolumn 33d, are populated with the quantitative measurements 300 kcals, 45%, 0%, and 0% respectively in the row 36, reflecting measured values for the Kraft™ product.

In at least one embodiment of the invention, a sampling of representative products already known as appealing to consumers may be selected for the purpose of determining suitable sensory and nutritional attributes of the target food. These qualities need not be established empirically as set forth in this enabling embodiment of the invention but are here taught to show a means of determining which purees and what quantities the purees are to be incorporated into the base recipe to yield a recipe for a target food product.

In a first embodiment, the sensory attributes of the target food product are not known. While, as set forth above, quantitative measurement of sensory attributes is not necessary to perform the invention, in this embodiment, attributes of the target food product are derived from known formulations of the target food, known either through commercial success, focus group study, market surveys, of other means of populating a sample set representative of consumer demand.

To establish sensory attributes for the target food product, the table 21 is populated by measuring and recording selected sensory attributes of each of the selected representative samples. Perceived color can be measured by at least one color characteristic including hue, brightness, and saturation. The range of tolerances set forth in columns 30a, 30b, 30c, 30d, 33a, 33b, 33c, and 33d, are used to select a puree or a combination of purees in the selected quantities. In a similar manner, the sensory attribute of perceived taste of the target food product. Attributes of the perceived taste are measured by a battery of known methods including the measurement of the acidity (pH). Sweetness is another taste attribute to be measured by using, in this nonlimiting example, the degrees BRIX.

The next sensory attribute, that of perceived texture of the target food product, can be measured by at least one texture characteristic including Baumé degrees, density, viscosity, and particle size. The Baumé scale is a hydrometer scale developed by French pharmacist Antoine Baumé in 1768 to measure density of various liquids. Notations include the following: degrees Baume, degrees Baumé, B°, Be°, Bé°, Baume.

All of the selected samples are measured for each of the sensory attributes set forth under the “Sensory Attributes” column 30; variously, the “Acidity” subcolumn 30a, the “Sweetness” subcolumn 30b, the “Viscosity” subcolumn 30c, and the “Color” subcolumn 30d. They are measured by known means until each row of the representative sample set, as set forth in a section 36, is complete.

While measurement means are known for each of the attributes, the units of measurement are not critical to the process. For example, if measurement of the mass ratio of dissolved sugar to water in a liquid is accomplished by degrees BRIX, all other measurements of that same sensory attribute should be performed either according to the same degrees BRIX measurement or by any measurement method, e.g. Baling, that can readily be converted to degrees BRIX for purposes of a more accurate comparison.

To establish a range of desirable sensory attributes, the measured attributes of the representative samples are arithmetically calculated to derive a mean value for each in the row 39a. Thus, a mean μ is readily calculated and recorded for each of the “Acidity” subcolumn 30a, the “Sweetness” subcolumn 30b, the “Viscosity” subcolumn 30c, and the “Color” subcolumn 30d. In a similar manner, a standard deviation σ is also calculated and recorded in each of the “Acidity” subcolumn 30a, the “Sweetness” subcolumn 30b, the “Viscosity” subcolumn 30c, and the “Color” subcolumn 30d.

To establish a range for acceptable values for each of sensory attributes as they will exist in the targeted food product, the standard deviation from the row 39b drives upper and lower thresholds for the values then found in rows 39c and 39d respectively. In practice, one often assumes that the data are from an approximately normally distributed population. The classical central limit theorem states that sums of many independent, identically distributed random variables tend towards the normal distribution as a limit. Thus, because the results measured for each of the representative samples and the group of samples as a whole is presumed to be normally distributed, then approximately 68% of the values are within 1 standard deviation of the mean, about 95% of the values are within two standard deviations and about 99.7% lie within 3 standard deviations. This is known as the 68-95-99.7 rule, or the empirical rule.

Though not required by the analysis, for purposes of this nonlimiting example, three standard deviations are used to characterize the representative sample. Using three standard deviations, the range of tolerance for each sensory attribute is calculated using the formula TU=μ+3*σ/√n, where n is equal to the number of representative samples of target food product recipes of the target food product, μ is the calculated mean of all sensory attribute measurements for a selected sensory attribute of the representative samples of target food product recipes, and σ is the calculated standard deviation of all sensory attribute measurements for a selected sensory attribute of the representative samples of target food product recipes. As above, the values are calculated and recorded in the rows 39c and 39d.

When, in the course of populating the data table 21 shown in FIG. 2 statistical outliers are identified, the existence of such outliers suggests that taste testing at a block 22 would be advantageous. Though each of the representative samples selected at the block 12 were selected because of the popularity the representative sample enjoys among a target audience, it is possible that certain of the products, though identified as being representative of the target food selected, are, in fact, a distinct food having a distinctly different taste. For that reason, statistical outliers are advantageously tested to determine whether it is advisable to eliminate the outliers from the representative sample and then to re-perform statistical calculations described with respect to the rows 39c and 39d. If the taste testing indicates that the outlier is not so different as to be a distinct food, in the opinion of taste testers, statistical calculations of the section 39 are retained to establish the range of tolerance.

Again, mathematic operations are used to then populate some of the remaining columns. While not necessary, in this exemplary embodiment, the range of tolerance is calculated for the target food product according to an equation: TU/L=μ+3*σ/√n for each given nutritional attribute, which is then tabulated in rows labeled “Limits” under each individual column heading under the main “Nutritional Attributes” column 33, the “Calories” subcolumn 33a, the “Fat Calories” subcolumn 33b, the “Vitamin A” subcolumn 33c, and the “Vitamin C” subcolumn 33d.

In the instant example, a new recipe for the macaroni and cheese target food product is formulated to enhance the nutritional value by reducing fat content per unit serving while simultaneously increasing vitamin and mineral content. The nutritional attributes of the target food are selected based upon a base recipe from which to prepare the target food. In the case of macaroni and cheese, as discussed above, the target nutritional criteria includes reduction of the percentage of calories derived from fat content and increase of the vitamin and mineral content in a unit volume. The target nutritional criteria for the exemplary formulation of macaroni and cheese include a value for the percentage of calories derived from fat (“fat calories”). The nutritional criteria also include a nonzero value for a percentage of Recommended Daily Allowances of Vitamin A and Vitamin C.

The systematic addition of purees to known formulations of the target food to a food of the target type prepared according to a basic recipe produces an interim product. In this example, it is advantageous to use one of the representative samples as a basic recipe. Alternate means include selection of a base recipe by means of focus testing of a series of known recipes. Another means is simple selection of a recipe from a popular formulation of the recipe. Other methods may be used to arrive at a base recipe, but in every case, a prepared food of the base recipe is tested in order to determine the measure of each of the sensory attributes of the product prepared by the known base recipe.

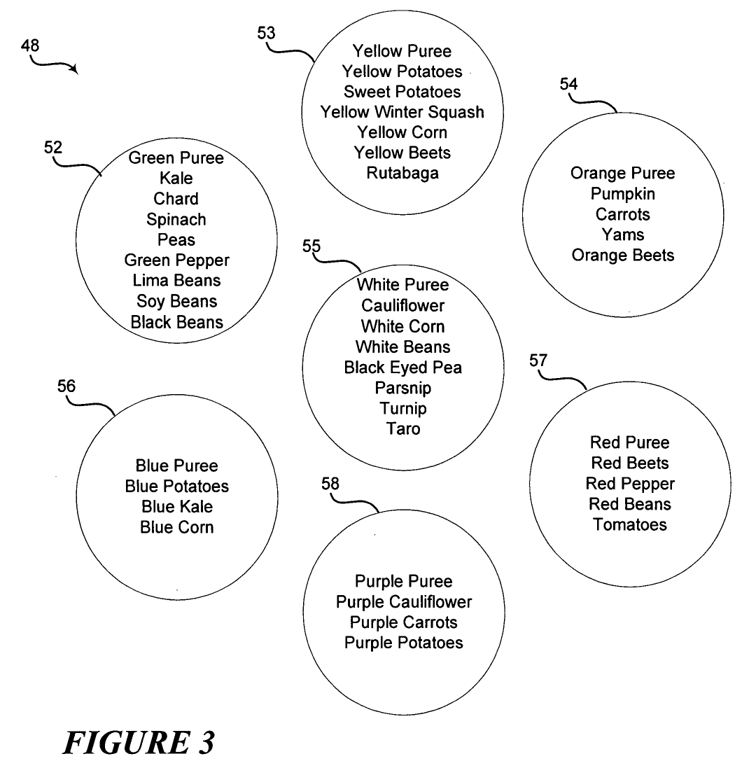

Purees are made from mixtures of vegetables, whole grains, lean proteins, and other natural ingredients. FIG. 3 includes a color spectrum diagram 48 of nonlimiting samples of vegetables which can be used to prepare color-based purees for incorporation into the target food product recipes to nutritionally enrich the target food product. These purees are examples of purees with known sensory and nutritional attributes studied in a manner similar to the testing of the representative samples to derive attributes that are then known attributes of the purees. Because the incorporation of the purees affects each of the measured attributes of the base recipe in a predictable manner, mathematical modeling of the incorporation can occur to determine the recipe of the target food.

Exemplary purees included in the spectrum chart 48 include vegetable purees including yellow-colored purees 53, orange-colored purees 54, red-colored purees 57, purple-colored purees 58, blue-colored purees 56, green-colored purees 52 and white-colored purees 55. Combinations of colored purees can be combined to achieve alternative variations in color while also achieving the nutritional content desired for the enriched target food product recipe. For example, it may be desirable to combine a yellow-colored puree 53 and a red-colored puree 57 to achieve an alternate puree which is orange colored, while also meeting a high vitamin C content. Examples of primary colored purees include yellow-colored purees 53 made with yellow potatoes, sweet potatoes, yellow winter squash, yellow corn, yellow beets, and rutabaga. Orange-colored purees 54 can be made with pumpkin, carrots, yams, and orange beets, amongst others, but can also be achieved by combining yellow-colored purees 53 and red-colored purees 57. Red-colored purees 57 can be made with red beets, red pepper, red beans, and tomatoes, amongst others. Purple-colored purees 58 can be made with purple cauliflower, purple carrots, and purple potatoes, amongst others, but can also be achieved by combining red-colored purees 57 and blue-colored purees 56. Blue-colored purees 56 can be made with blue potatoes, blue kale, and blue corn, amongst others. Green-colored purees 52 can be made with kale, chard, spinach, peas, green pepper, lima beans, soy beans, and black beans, amongst others, where special consideration is taken for the bitter taste of leafy green vegetables. White-colored purees 55 can be made with cauliflower, white corn, white beans, black eyed peas, parsnips, parsnip, turnip, and taro, amongst others.

A puree is selected according to the color spectrum chart 48, FIG. 3, that is yellow in color, low in fat, and high in vitamin A and C for incorporation into the base recipe for macaroni and cheese. The selection of a puree other than yellow for incorporation, for example, a puree including broccoli “B4” in the row 42d, would alter the expected color and thus cause the resulting mixture to fall outside of the calculated tolerance range for color derived at the block 40. Incorporation into the selected base recipe of a pureed mix of ingredients made from butternut squash “B1” in row 42a, or sweet potato “B2” in row 42b, or butternut and sweet potato “B3” in row 42c would not alter the color of the resulting food product to be outside of the calculated tolerance range for color.

The base recipe is, in this first quantitative embodiment, selectively augmented by incorporating pureed mixes of ingredients; incorporation of a first puree combination as needed to derive a first formulation recorded in a row 42a and recorded under the column 24 as “B1”. A second puree combination for a second formulation is likewise recorded in row 42b and is identified in the column 24 as “B2.” A third combination for a third formulation, in this nonlimiting example, is recorded in row 42c as “B3” and a fourth in row 42d, under column 24 as “B4.” As above, a verbose name for each sample is recorded in the corresponding row under the column 27 and measured and recorded for each of the columns 30a, 30b, 30c, 30d, 33a, 33b, 33c, and 33d, also in the manner as the row 36a was populated in the discussion above.

As a result of the mathematical modeling of the incorporation process, often more than one acceptable formulation of the recipe can be derived by incorporation into the basic recipe as is evidenced by the recipes recorded at rows 42a, 42b, and 42c. Rigorous taste, appearance, texture, and nutritional testing of the combinations further narrow the selection of the combinations to arrive at a single recipe.

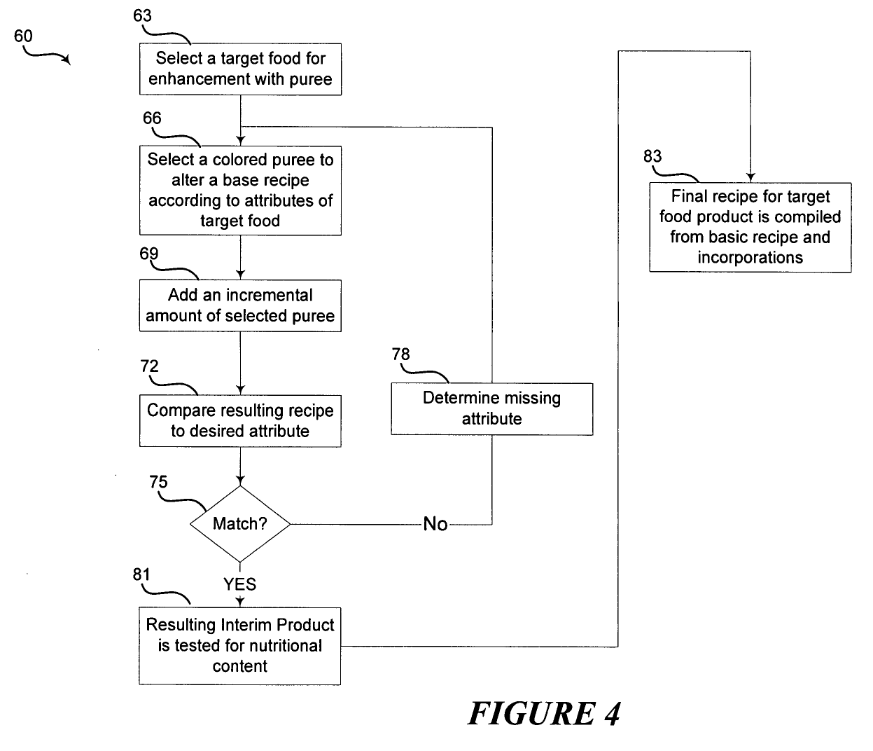

A second embodiment is exhibited in the method 60 set forth in FIG. 4. As stated above, the embodiment is enabled through the use of qualitative rather than quantitative methodology. Rather than using the statistical methodology employed to populate the table 21 (FIG. 2), the method 60 relies upon comparing sensory attributes based upon know qualities of purees. Because of the sensory nature of the attributes, the selection of a puree for addition is based upon known qualities of a group of purees as represented by the color spectrum chart 48 (FIG. 3). Because color is the most noticeable attribute of a target food, arranging the purees as a color spectrum chart 48 (FIG. 3) enables color-based selection of purees for incremental addition.

At a block 63, a target food is selected, generally, according the above-discussed criterion of moisture of a principal component falling between 25 and 95 percent. In selecting a target food, a base recipe is also selected to approximate the sensory and nutritional attributes of the target food.

At a block 66, a puree for incorporation is selected according to a sensory attribute, generally, color. Either through direct observation by a trained observer or by means of hue matching by spectroscopic examination of the purees and the product according to a base recipe, a puree is selected to approximate the color of the target food product.

At a block 69, a selected incremental amount of the puree is added to the product according to the base recipe to produce an intermediate product. The incremental amount may either be selected according to a selected constant amount or according to a perceived difference between the product according to the basic recipe and the target food product.

At a block 72, the intermediate product is compared to the desired target food product. Differences in the sensory attributes are noted generally in an order that agrees with the importance that a consumer places on those attributes. Color, being tied with the predominant sense of sight is first. After color, generally, in order acidity, sweetness, and texture determine selection of purees for incorporation. Differences in each of the sensory attributes are noted. If in tasting and seeing the interim product a match, at a block 75, a match is determined to exist, the method 60 continues to completion at a block 81.

If, however, the interim product is determined not to match the target food product, the method 60 loops through a block 78 to continue adjustment of the interim product to reflect differences noted at the block 78 between the interim product and the target food product. As a feedback circuit, only one sensory attribute is allowed to vary and then only within a narrow range around a certain optimal level under certain environmental conditions. The deviation of the optimal value of the sensory attribute can result from the changes occasioned within the interim product by addition of the puree. Ultimately, the loop continues through the blocks 66, 69, 72, 75, and 78 until the interim product well approximates the target product.

Once a match is detected at the block 75, the resulting interim product is tested for nutritional makeup. Such testing, while desirable is not necessary to the method 60. Once the interim product is found to successfully match the target product in both sensory and nutritional attributes, the recipe is compiled from the base recipe and the several incorporated purees added at the one or several instances wherein the method 60 progressed through the block 69. In this manner, the final product can be reliably reproduced without testing of interim products.

While the preferred embodiment of the invention has been illustrated and described, as noted above, many changes can be made without departing from the spirit and scope of the invention. In this case, the choice of the macaroni and cheese recipe as a representative target food product, and the development of a nutritionally enriched recipe for macaroni and cheese are exemplary. The food development method detailed here will understandably vary according to the selected target food product under development, the representative recipes selected, the sensory attributes measured, the desirable sensory attributes for the given target food, the selected nutritional attributes sought to be enriched in the target food product, and the ingredients incorporated into the puree to nutritionally enrich the target food product recipe. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for enhancing a nutritional value of a target food product without significantly changing an established sensory profile of the target food product comprising the steps of:
selecting a target food according to a moisture content of a principal component;
preparing a base recipe based upon the target food;
observing a color of the principal component to determine a component color;
selecting a puree for addition to the base recipe according to the component color; and
incorporating an incremental amount of the puree into the base recipe to form an interim recipe.

2. The method of claim 1 wherein the puree of ingredients includes vegetables selected according to the component color.

3. The method of claim 2, wherein selecting the puree further includes selecting the puree from a spectrum of purees arranged by color.

4. The method of claim 1 wherein the puree of ingredients selected includes whole grains.

5. The method of claim 1 wherein the puree of ingredients includes proteins.

6. The method of claim 1 further comprising:
comparing the interim recipe to the target food according to at least one of color, texture, acidity, and sweetness.

7. A system for augmenting a basic recipe to produce a target food, the system comprising:
a basic recipe selected based upon the target food; and
at least one puree for incorporation into the basic recipe to produce an interim food, the puree being selected from a group consisting of red puree, blue puree, green puree, white puree, yellow puree, purple puree, orange puree and combinations thereof.

8. The system of claim 7, wherein the red puree includes:
at least one ingredient selected from a red collection of ingredients consisting of red beets, red pepper, red beans, tomatoes and combinations thereof.

9. The system of claim 7, wherein the yellow puree includes:
at least one ingredient selected from a yellow collection of ingredients consisting of yellow potatoes, sweet potatoes, yellow winter squash, yellow corn, yellow beets, rutabaga and combinations thereof.

10. The system of claim 7, wherein the orange puree includes:
at least one ingredient selected from an orange collection of ingredients consisting of pumpkin, carrots, yams, orange beets and combinations thereof.

11. The system of claim 7, wherein the purple puree includes:
at least one ingredient selected from a purple collection of ingredients including purple cauliflower, purple carrots, purple potatoes and combinations thereof.

12. The system of claim 7, wherein the green puree includes:
at least one ingredient selected from a green collection of ingredients including kale, chard, spinach, peas, green pepper, lima beans, soy beans, black beans and combinations thereof.

13. The system of claim 7, wherein the white puree includes:
at least one ingredient selected from a white collection of ingredients including white corn, white beans, black eyed peas, parsnips, parsnip, turnip, taro and combinations thereof.

14. The system of claim 7, wherein the at least one puree for incorporation is selected based upon a color of the target food.

15. The system of claim 14, wherein the at least one puree is a combination of at least two purees blended to match the color of the target food.

16. A method for enhancing a nutritional value of a target food product without significantly changing an established sensory profile of the target food product comprising the steps of:
selecting a base recipe according to the target food;
selecting at least one member of a set of representative samples according to the target food;
measuring at least one sensory attribute to determine a value for each member of the set of representative samples;
establishing an upper and a lower threshold value for the at least one sensory attribute based upon the measured value of the at least one sensory attribute as present in the representative sample; and
incorporating a puree having a known values for the at least one sensory attribute and the at least one nutritional attribute into the product to alter the base recipe to a value within the a range between the upper and lower threshold values for the at least one sensory attribute.

17. The method of claim 16 wherein the at least one sensory attribute includes attributes selected from the attribute group, acidity (pH), sweetness (BRIX) color, and texture.

18. The method of claim 17 wherein the at least one sensory attribute includes color as measured by at least one color characteristic selected from a group consisting of hue, brightness, and saturation.

19. The method of claim 16 wherein the at least one texture characteristic is selected from a group consisting of Baume, density, viscosity, and particle size, wherein the new recipe must fall within a range of tolerance for at least one texture characteristic.
